(19) United States
(12) Patent Application Publication
(10) Pub. No.: US 2026/0245422 A1
(43) Pub. Date: Aug. 20, 2026

(54) EGM GENERATIVE AI

(71) Applicant: Aristocrat Technologies, Inc., Las Vegas, NV (US)

(72) Inventor: Robert Butler, Austin, TX (US)

(21) Appl. No.: 19/538,424

(22) Filed: Feb. 12, 2026

Related U.S. Application Data
(60) Provisional application No. 63/863,204, filed on Aug. 13, 2025.
(60) Provisional application No. 63/759,987, filed on Feb. 18, 2025.

(51) Int. Cl. G07F 17/32; G06N 3/0475

(52) U.S. Cl. CPC G07F 17/3202; G06N 3/0475; G07F 17/3239

(57) ABSTRACT

Dynamically generating and replacing gaming assets involves initiating a gaming session for an electronic game at an electronic gaming machine, where the game is associated with generic gaming assets. During the session, various characteristics of the gaming session are determined. An asset creation model generates session-specific gaming assets based on the session characteristics. The generic gaming assets are then replaced with the session-specific gaming assets generated during the session. The gaming session proceeds with the newly generated session-specific assets, creating a unique gaming experience. The asset creation model employs a generative AI model to create the session-specific assets, enhancing the gaming experience by tailoring the assets to the specific session characteristics. A compliance score for the session-specific gaming assets is determined and compared against a predefined criterion prior to replacing the generic assets with the session-specific assets.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome, and symbols are then selected which correspond to that outcome. Notably, some games may include an element of skill on the part of the player and are therefore not entirely random.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts a flowchart of a technique for generating and deploying session-specific gaming assets, in accordance with one or more embodiments.

FIG. 5 depicts a system diagram of an EGM configured to generate session-specific gaming assets, in accordance with one or more embodiments.

FIG. 6 depicts a flow diagram of a process for using an asset creation model, in accordance with one or more embodiments.

FIG. 7 depicts an alternative flow diagram illustrating an example data flow for generating session-specific gaming assets, according to one or more embodiments.

### DETAILED DESCRIPTION

The following description relates generally to gaming systems and methods for generating session-specific gaming assets during a gaming session at an electronic gaming machine (EGM). More specifically, techniques described herein are directed to utilizing a specialized hardware and an asset creation model, to generate, on the fly, a unique gaming experience that is derived from characteristics of an ongoing gaming session.

According to some embodiments, an electronic gaming machine is configured to include specialized hardware to run an asset creation model on device during a gaming session. The asset creation model may include one or more artificial intelligence (AI) models, such as generative AI networks, to generate session-specific gaming assets for an ongoing session of a game based on session characteristics, such as characteristics of a player, the gameplay, or other contextual information. The session-specific assets include modifications of generic gaming assets for the ongoing game, or may be newly created assets that may replace preexisting assets in the game for the session. In doing so, the gaming experience is transformed into a dynamic, personalized experience.

Traditionally, image and audio assets for EGMs are provided as part of a gaming package. In addition, the gaming assets often must be approved by gaming regulators before the game's release and thus, are unlikely to change once deployed onto an EGM. In addition, it may be difficult to constantly transmit data to an EGM live in a casino, due to bandwidth and compute limitations. These hurdles lead to a static and unchanging user experience. The techniques described herein leverage a generative AI model configured to dynamically generate gaming assets during a gaming session based on characteristics of that gaming session. Techniques described herein improve upon preexisting systems by incorporating a specialized hardware into the EGM such that session-specific assets can be generated locally, on the fly. The AI model is trained with pre-approved image and audio assets to ensure compliance with regulatory standards. In addition, a filtering step is performed to ensure compliance of generated content.

The following description is presented to enable any person skilled in the art to make and use the disclosure, and is provided in the context of a particular application and its requirements. Various modifications to the disclosed embodiments will be readily apparent to those skilled in the art, and the general principles defined herein may be applied to other embodiments and applications without departing from the scope of the disclosure. Thus, the present disclosure is not intended to be limited to the embodiments shown, but is to be accorded the widest scope consistent with the principles and features disclosed herein.

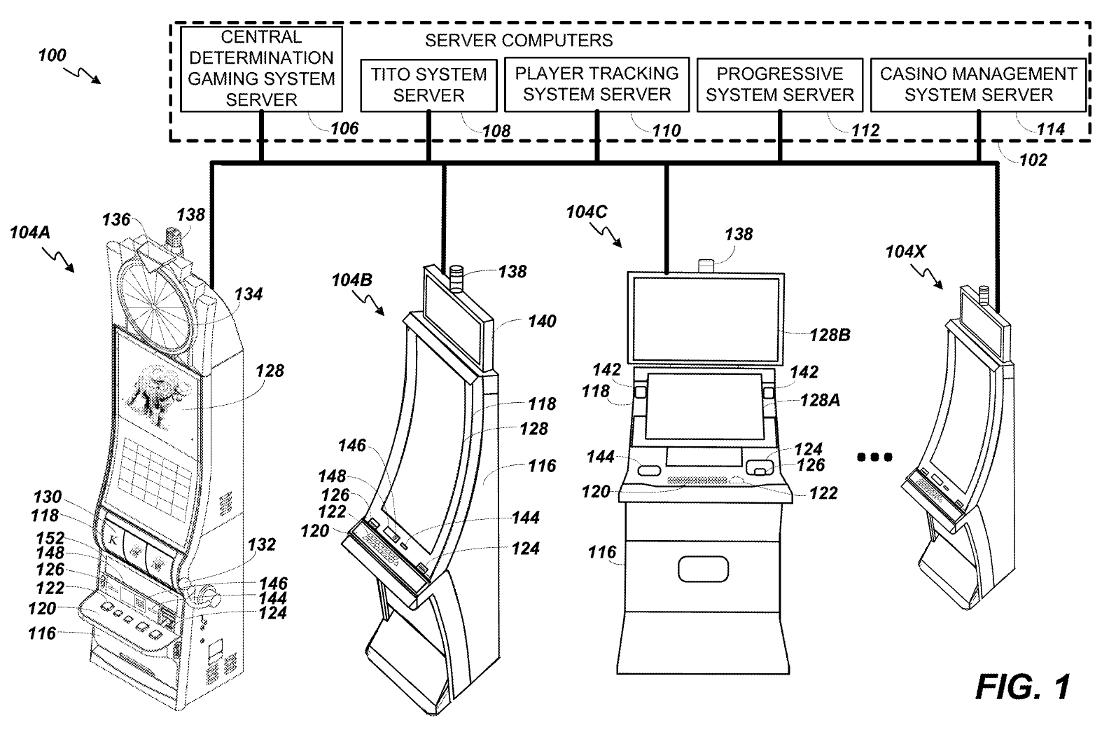

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system (CMS) 114, which may include one or more servers. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL^{TM} model gaming device manufactured by Aristocrat^{®} Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

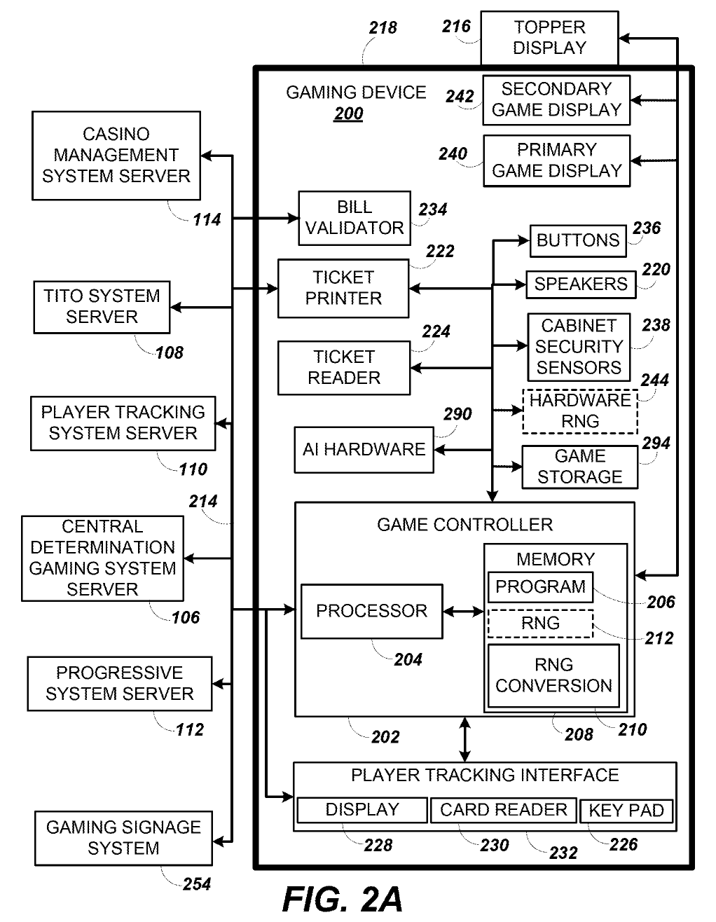

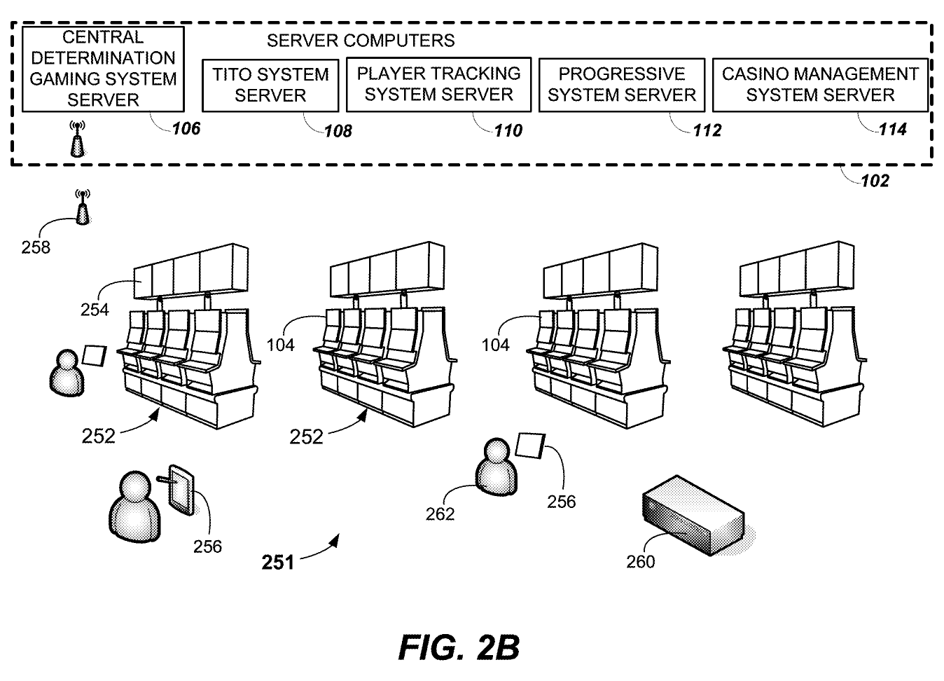

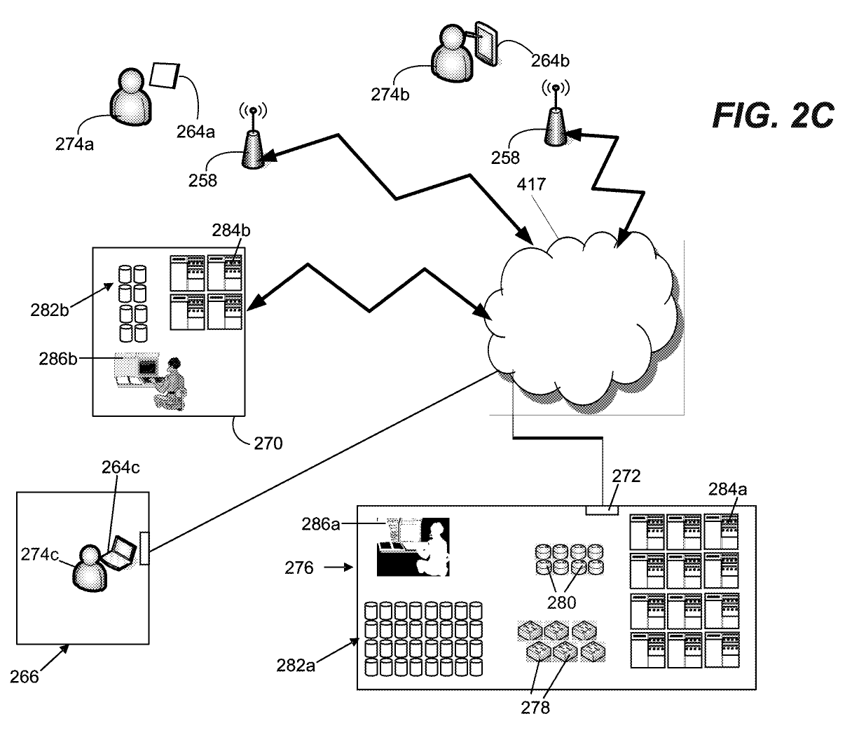

Many or all of the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc^{TM} model gaming device manufactured by Aristocrat^{®} Technologies, Inc. Note that where possible, reference numerals identifying similar features of the gaming device 104A implementation are also identified in the gaming device 104B implementation using the same reference numbers. Gaming device 104B does not include physical reels and instead shows gameplay functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify, and/or upgrade the software, and for general maintenance operations.

Another example gaming device 104C shown is the Helix^{TM} model gaming device manufactured by Aristocrat^{®} Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary gameplay while secondary display 128B is typically used for bonus gameplay, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player’s credit value, a ticket reader 224 which reads bar-coded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that does not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents computer readable code stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

According to one or more embodiments, gaming device 200 may include a game storage 294, which may be a non-transitory storage device. Game storage 294 may store gaming data, for example for use by program 206. This may include, for example, digital assets such as image files, audio data, or other media items that are used by program 206. Further, in some embodiments, the game storage 294 may store characteristics of a player and/or gaming session. For example, the game storage 294 may store data related to user play behavior, behavioral history, or the like. Additionally, or alternatively, the characteristics of the player and/or gaming session may be stored in memory 208 for a particular gaming session. In some embodiments, game storage 294 may be accessible by game controller 202 within the gaming device 200. In some embodiments, game storage 294 may be comprised in game device 200.

Gaming device 200 may also include AI hardware 290. AI hardware 290 may be a specialized hardware device configured to run one or more artificial intelligence-enabled networks or models. The AI hardware 290 may include any type of hardware device or component that is designed or optimized for performing artificial neural network computations, such as a neuromorphic chip, a field programmable gate array (FPGA), a tensor processing unit (TPU), a neural processing unit (NPU), a vision processing unit (VPU), a graphics processing unit (GPU), or any other suitable hardware device or component. As shown, the AI hardware 290 may be comprised in the EGM 200, or may be located outside the EGM 200 and communicatively coupled to the EGM 200 via a wired or wireless connection. Further, in some embodiments, the AI hardware 290 may be comprised in the game controller 202.

According to one or more embodiments, the AI hardware 290 may be configured to generate session-specific assets for a gaming session. The session-specific assets may be generated using an AI-enabled model, such as a generative AI model. The model may be configured to use session-specific data, such as player data, behavioral data, outcome history, or the like, to generate new assets for the game, or adjust preexisting assets.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS^{®} system manufactured by Aristocrat^{®} Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment, and/or additional play. Player tracking information may be combined with other information that is now readily obtainable by a casino management system (CMS).

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during the course of gameplay (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones, and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online gameplay. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player’s EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a–274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online gameplay, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a–274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

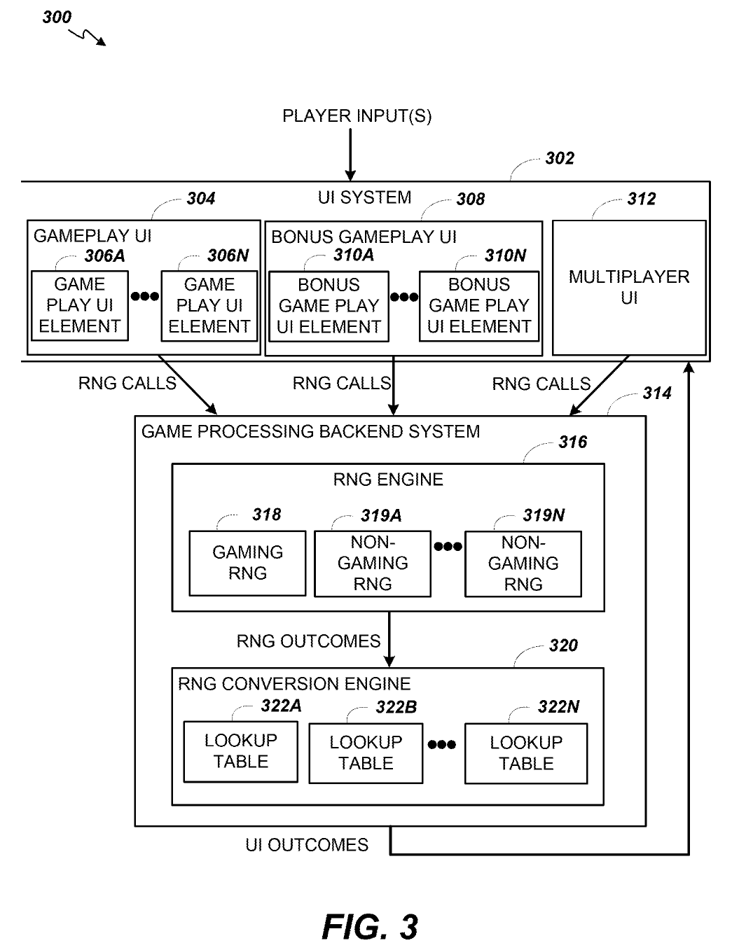

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more gameplay UIs 304, one or more bonus gameplay UIs 308, and one or more multiplayer UIs 312, where each UI type includes one or more mechanical UIs and/or graphical UIs (GUIs). In other words, gameplay UI 304, bonus gameplay UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present gameplay to a player. Using FIG. 3 as an example, the different UI elements are shown as gameplay UI elements 306A-306N and bonus gameplay UI elements 310A-310N.

The gameplay UI 304 represents a UI that a player typically interfaces with for a base game. During a game instance of a base game, the gameplay UI elements 306A-306N (e.g., GUI elements depicting one or more virtual reels) are shown and/or made available to a user. In a subsequent game instance, the UI system 302 could transition out of the base game to one or more bonus games. The bonus gameplay UI 308 represents a UI that utilizes bonus gameplay UI elements 310A-310N for a player to interact with and/or view during a bonus game. In one or more implementations, at least some of the gameplay UI elements 306A-306N are similar to the bonus gameplay UI elements 310A-310N. In other implementations, the gameplay UI element 306A-306N can differ from the bonus gameplay UI elements 310A-310N.

FIG. 3 also illustrates that UI system 302 could include a multiplayer UI 312 purposed for gameplay that differs or is separate from the typical base game. For example, multiplayer UI 312 could be set up to receive player inputs and/or presents gameplay information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player’s gaming experience, tournament mode can modify and synchronize sound, music, reel spin speed, and/or other operations of the gaming devices according to the tournament gameplay. After tournament gameplay ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for gameplay. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more gameplay UI elements 306A-306N, such as symbols, for the gameplay UI 304. In another example, if the UI outcome is for a bonus game, the UI system could update one or more bonus gameplay UI elements 310A-310N (e.g., symbols) for the bonus gameplay UI 308. In response to updating the appropriate UI, the player may subsequently provide additional player inputs to initiate a subsequent game instance that progresses through the game processing pipeline.

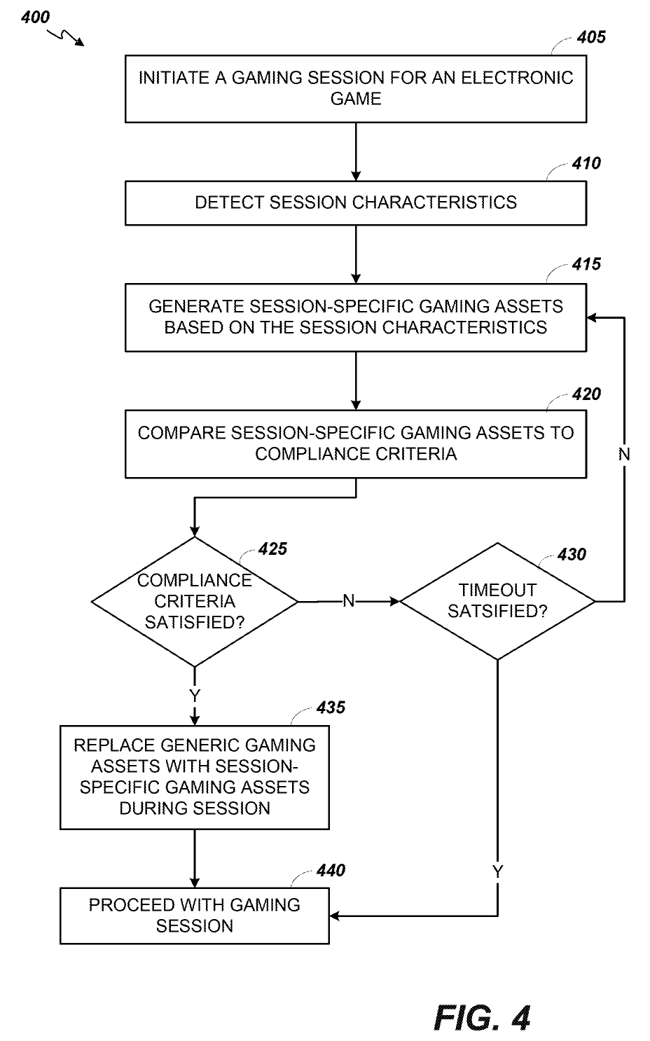

In some embodiments, the content presented on the UI may include gaming assets in the form of media items for the game. FIG. 4 is a flow diagram illustrating an example method for generating session-specific gaming assets during a gaming session at an EGM, according to one or more embodiments. For purposes of clarity, the various processes are described as being performed by particular components. However, in some embodiments, the various processes may be performed by additional or alternative components. Although the flow diagram depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed.

The flowchart 400 begins at block 405, where the EGM initiates a gaming session for an electronic game. The electronic game may be any type of game of chance or skill that is playable on the EGM, such as a slot machine game, a video poker game, a keno game, a bingo game, a roulette game, a blackjack game, or any other suitable game. The electronic game may be associated with one or more generic gaming assets, which may include one or more media items for the electronic game, such as images, symbols, animations, sounds, music, voiceovers, text, or any other suitable media items. The generic gaming assets for the game may be presented to a player by the EGM during a gameplay session. In some embodiments, the generic gaming assets may be predefined and approved by gaming regulators prior to the release of the electronic game.

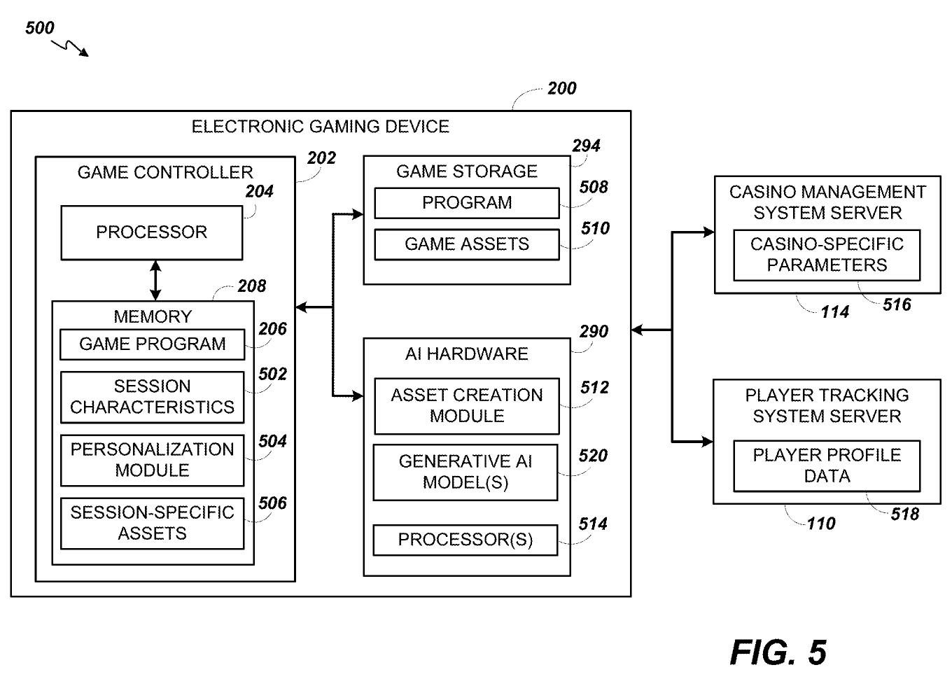

Turning to FIG. 5, a network diagram 500 is presented in which the EGM 200 is communicably connected to a casino management system server 114 and a player tracking system server 110. The EGM 200 may include game controller 202, along with game storage 294, and AI hardware 290. When the EGM 200 initiates a game, the game may be executed from game program 206 within memory 208 of the EGM. The program code that makes up the game program may be executed by processor 204. In some embodiments, the program code 508 may be loaded into game controller 202 from game storage 294. The game may be associated with predefined, generic media items that make up the gaming assets. These assets may be specific to the game, but generic to the game session. In some embodiments, the generic gaming assets are defined prior to the beginning of the gaming session, and may be the same at multiple EGMs. The generic gaming assets may be associated with a single game, or multiple games. The generic gaming assets may be stored on the EGM, for example as gaming assets 510 in game storage 294. Alternatively, the generic gaming asset may be stored on a storage device communicatively coupled to the EGM, or on a remote server computer accessible by the EGM. When the gaming session is initiated by the game controller 202, the generic gaming assets from gaming assets 510 are used.

Returning to FIG. 4, the flowchart 400 continues to block 410, where the system detects one or more characteristics of the gaming session. The session characteristics may include any information or data that relates to the gaming session, such as the identity of the player, location of the EGM, time and date of the gaming session, duration of the gaming session, wager amount, the game outcome, user interaction or behavioral data, and the like. In some embodiments, the session characteristics may be tracked by a tracking module and stored in memory within the EGM. In some embodiments, session characteristics may include characteristics to a specific player, such as user preferences, user profile data, user loyalty data, the user feedback data, or the like. These characteristics may be obtained from the EGM, for example, from a player tracking server, or the like. In some embodiments, the characteristics of the gaming session may include contextual information for the session, such as casino-specific parameters, property-specific parameters, event-specific parameters, advertiser-specific parameters, or any other suitable characteristics.

The system may detect the characteristics by using various sensors, devices, or interfaces on the EGM. The system may also detect the characteristics by receiving data from one or more server computers communicatively coupled to the EGM. Returning to FIG. 5, the casino-specific parameters 516 may be obtained from casino management system server 114. The casino-specific parameters may include data which can be used as input for generating the session-specific assets. For example, a casino logo or color scheme may be identified in the casino-specific parameters and may be defined by a casino, or the like. The player profile data 518 may be obtained from the player tracking system server 110. The player profile data 518 may include any information or data that identifies or relates to the user, such as the user name, the user age, the user gender, the user ethnicity, the user location, the user loyalty level, the user loyalty points, the user game history, the user game preferences, the user game behavior, the user game feedback, or any other suitable information or data. In some embodiments, the player profile data may be specific to a gaming session at the EGM 200, or may be based on historic and/or predefined behaviors and preferences for the player.

Returning to FIG. 4, the flowchart 400 proceeds to block 415, where one or more session-specific gaming assets are generated based on the one or more characteristics and using the asset creation model. The session-specific gaming assets may include one or more variations of the generic gaming assets that are dynamically created and customized for the gaming session, such as different image assets, sound assets, voice assets, text assets, or any other suitable media items for an electronic game that has been loaded onto the EGM. The session-specific gaming assets may be generated by applying session-specific parameters to an asset creation model to modify preexisting gaming assets, or generate wholly new gaming assets.

The session-specific gaming assets may be generated by calling functionality from a specialized hardware onboard the EGM, which is configured to execute the asset creation model. As shown in FIG. 5, game controller 202 may include, in memory 208, a personalization module 504. Personalization module 504 may include one or more computer readable instructions or code that implement the logic and functionality of personalizing the gaming session based on session characteristics, such as the session characteristics 502 detected at block 410. In addition, personalization module 504 may track player behavior, game outcome, and other parameters of the game session, and store them, for example in session characteristics 502 of memory 208.

Personalization module 504 may work in conjunction with game program 206 to determine when to generate session-specific assets. For example, the game program 206 may include checkpoints or other indicators at which point session-specific assets should be generated. Alternatively, personalization module 504 may track the gaming session and generate the session-specific assets in response to a triggering event, such as lapsed time, game outcome, user input, or the like. Personalization module 504 may then call the AI hardware 290 to generate the session-specific assets.

AI hardware 290 may be a specialized device or component that is configured to execute the asset creation model 512, which may include a generative AI model, as described in more detail below. The AI hardware 290 may include any type of hardware device or component that is designed or optimized for performing artificial neural network computations, such as a neuromorphic chip, a field programmable gate array (FPGA), a tensor processing unit (TPU), a neural processing unit (NPU), a vision processing unit (VPU), a graphics processing unit (GPU), or any other suitable hardware device or component. The AI hardware may include one or more processor(s) 514 which may be configured to perform particular instructions, such as the asset creation module 512. Further, the processor(s) 514 may include multiple computer processors, and may be of multiple types. The AI hardware 290 may be comprised in the EGM 200, or may be located outside the EGM 200 and communicatively coupled to the EGM 200 via a wired or wireless connection. The AI hardware 290 may receive the characteristics of the gaming session from the session characteristics 502, as well as other considerations for the session-specific assets, such as the casino-specific parameters 516, and/or the player profile data 518. Further, the AI hardware 290 may be comprised of multiple components that are distributed, for example across a network.

The asset creation module 512 may include one or more computer readable instructions or code that implement the logic and functionality of generating session-specific gaming assets based on the characteristics of the gaming session. The asset creation module 512 may interface with one or more generative AI model(s) 520. The generative AI model(s) 520 may include one or more artificial neural networks, such as a generative adversarial network (GAN), a variational autoencoder (VAE), a recurrent neural network (RNN), or any other suitable artificial neural network. One or more of the generative AI model(s) 520 may be trained with a training data set that includes a plurality of generic gaming assets, for example generic gaming assets for the particular electronic game. Further, multiple generative AI models may be included that are trained for different tasks. In some embodiments, the training data is selected based on a determination that the generic gaming assets do not violate gaming regulations. The asset creation module 512 may dynamically create the session-specific gaming assets according to the one or more characteristics of the gaming session, such as player profile data, player preferences, player interactions, casino parameters, property parameters, event parameters, advertiser parameters, or any other suitable characteristics. The asset creation module may be configured to generate a range of asset types, such as a theme, a drawing or animation style, an area or category of interest in the game, or the like.

At block 420, a compliance score is determined for the one or more of the session-specific gaming assets, wherein the one or more of the generic gaming assets are replaced with the one or more session-specific gaming assets based on a determination that the compliance score satisfies a criterion. The compliance score may be a numerical or categorical value that indicates the degree of compliance of the session-specific gaming assets with the gaming regulations, such as the probability of generating inappropriate, erroneous, or offensive gaming assets, or the similarity of the session-specific gaming assets with the generic gaming assets.

A determination is made at block 425 as to whether the compliance criteria are satisfied. The criteria may be a threshold, a range, a rule, or any other suitable criterion that defines the acceptable level of compliance for the session-specific gaming assets. For example, a compliance score from block 420 can be compared against a predefined threshold score. As another example, the compliance score may provide other indicators which may be compared against predefined criteria for compliance.

If, at block 425, a determination is made that the compliance criteria are not satisfied, the flowchart may proceed to block 430. At block 430, a determination is made as to whether a timeout condition is satisfied. The timeout condition may be any condition that indicates that the system should discontinue generating session-specific assets. For example, the timeout condition may include the end of the gaming session, such as a user input, a game outcome, a wager amount, a duration, a location, a time, a date, a system event, a network event, a security event, or any other suitable condition. As another example, the timeout condition may be based on a threshold number of iterations, or a timespan, within which the system has failed to generate session-specific gaming assets that satisfy compliance criteria. In doing so, the timeout condition may keep a user engaged by avoiding excess computation that may affect performance of the EGM, or wait time that may affect a player experience. If the timeout condition is not satisfied, then the flowchart 400 returns to block 415, and new session-specific gaming assets are generated based on the session characteristics. The flowchart 400 then proceeds until compliance criteria are satisfied by generated session-specific gaming assets. Returning to block 430, if the timeout condition is satisfied, the flowchart 400 may conclude at block 440, and the gaming session may proceed using the predefined gaming assets, such as the generic gaming assets, or session-specific gaming assets which have already been generated and incorporated into an electronic game.

Returning to block 425, if the compliance criteria is satisfied, then the flowchart proceeds to block 435. At block 435, the personalization module 504 replaces, during the gaming session, one or more of the generic gaming assets with the one or more session-specific gaming assets that have satisfied the compliance criteria.

The flowchart 400 concludes at block 440, and the gaming session then proceeds using the one or more session-specific gaming assets. The replacement may occur at any time during the gaming session, such as at a predetermined interval, at a random interval, at a user request, at a game event, at a bonus event, at a progressive event, at a predefined time, or the like. The replacement may affect any portion of the electronic game, such as a primary game, a secondary game, a bonus game, or the like. In addition, the session-specific assets may be presented at ancillary or accessory displays or output devices, such as a topper display, game signage, game cabinet, or any other device. Turning to FIG. 5, the session-specific assets 506 may be stored in memory 208 for the duration of the gaming session. In some embodiments, the session-specific assets may be used for the duration of the gaming session, or a portion of the gaming session, and may be deleted or erased upon completion of the gaming session.

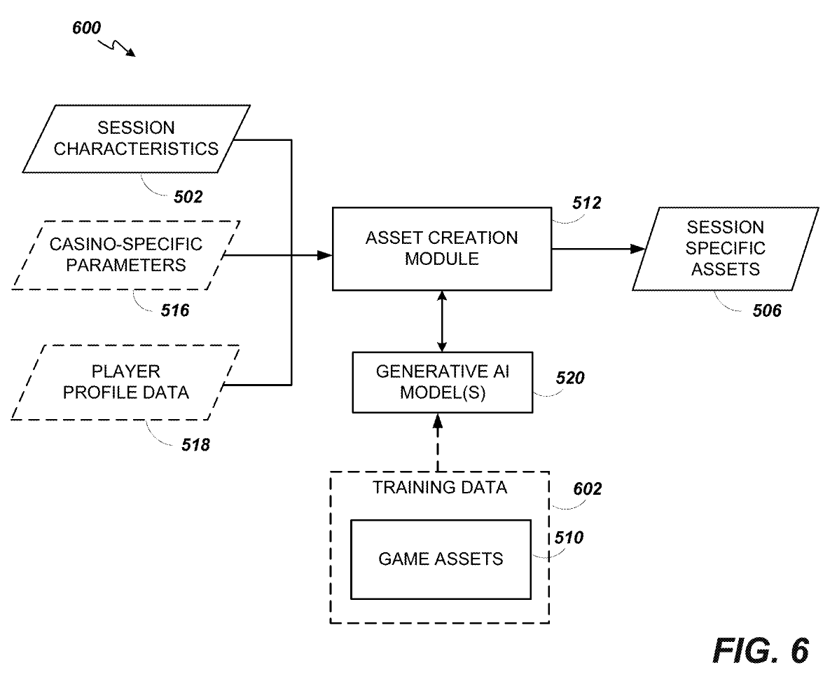

Turning to FIG. 6, a flow diagram 600 is presented illustrating an example data flow for generating session-specific gaming assets, according to one or more embodiments. The asset creation module 512 may include one or more trained networks. In some embodiments, the asset creation module 512 may be configured to interface with one or more generative AI model(s) 520, which may be any type of artificial neural network, such as a generative adversarial network (GAN), a variational autoencoder (VAE), a recurrent neural network (RNN), or the like, which are configured to generate new content based on a given prompt and historic content on which the model was trained.

In some embodiments, one or more of the generative AI model(s) 520 are trained on the training data 602. In some embodiments, the one or more generative AI model(s) 520 are trained prior to being commissioned on the EGM. The training data 602 may include a set of generic gaming assets that have been determined or confirmed to not violate gaming regulations, such as images, symbols, animations, sounds, music, voiceovers, text, or any other suitable media items. The training data 602 may originate from a particular game, game series, or set of games. Once trained, the one or more generative AI model(s) 520 may be provided to an EGM. For example, the asset one or more generative AI model(s) 520 may be loaded onto a specialized hardware that is installed in the EGM.

During a gameplay session, the asset creation module 512 can dynamically create and provide the session-specific assets 506 according to the session characteristics 502. Optionally, the asset creation module may additionally ingest the casino-specific parameters 516 and the player profile data 518, and any other suitable information or data related to the gaming session. The asset creation module 412 may use the various inputs and apply them to one or more generative AI model(s) 520 to generate the session-specific assets, where the one or more generative AI model(s) 520 generates the session-specific assets 506 based upon the training data 602 on which one or more of the generative AI model(s) 520 was trained.

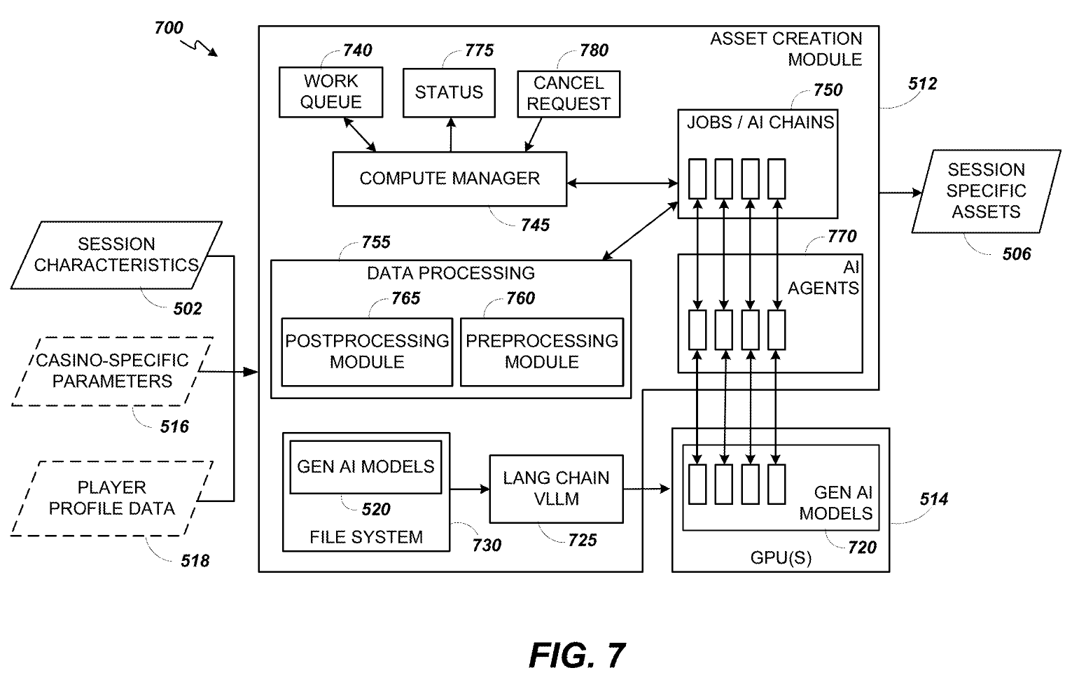

According to some embodiments, the specialized AI hardware 290 may support multithreaded, model-specific agents for handling asset requests. FIG. 7 depicts an alternative flow diagram illustrating an example data flow for generating session-specific gaming assets, according to one or more embodiments. In particular, FIG. 7 shows an embodiment in which the asset creation module 512 manages multithreaded agents for generating the content.

According to one or more embodiments, the asset creation module 512 acts as the umbrella orchestration layer responsible for coordinating job intake, model selection, hardware allocation, data preprocessing, inference execution, postprocessing, and result dissemination. In some embodiments, the pipeline exposes an application-programming interface (API), through which a client transmits a request for one or more AI generated assets. The asset creation module 512 receives jobs in the work queue 740, for example from a game program or other clients executing in an EGM. The work queue 740 may support a pull-based interface used by the compute manager 745 to provide the requested assets. In some embodiments, the work queue may maintain an arrival order, and may tag requests with other information used to generate the requested asset. In some embodiments, the request may be added to the work queue by a game program upon detecting an in-game event that triggers an asset request.

The Compute Manager 745 may include an intelligent scheduler that polls the Work Queue 740 for incoming requests, and may manage the scheduling of the tasks, including providing a status 775 for the incoming requests, or handling cancellations, such as cancel request 780. For example, a game program or other component may direct cancellation of a prior schedule request with compute manager 745.

The Compute Manager 745 may decompose an incoming asset request into one or more smaller tasks using data processing 755. Each of those tasks may be handled by jobs/AI chains 750. In some embodiment, the compute manager 745 may invoke preprocessing module 760 to prepare the request for being completed by the AI agents. For example, the preprocessing module 760 may determine task types, model behavior, or the like. The preprocessing module 760 may identify component types, such as avatar hand motion, facial animation, text request, or the preprocessing module 760 may rewrite the request or generate prompts to facilitate downstream inference, and generate entries for jobs/AI chains 750, in accordance with some embodiments. Further, the preprocessing module 760 may retrieve context to be used to generate the session-specific assets, such as the session characteristics 502. Optionally, the preprocessing module 760 may additionally retrieve the casino-specific parameters 516 and the player profile data 518, and any other suitable information or data related to the gaming session. The jobs/AI chain 750 may include a set of converted jobs or tasks prepared for processing by AI agents. This component may also track which tasks can be performed in parallel, and/or dependencies among the tasks. In some embodiments, the compute manager 745 may allocate each of the individual jobs or tasks from the jobs/AI chains 750 to one or more AI agents 770.

Each AI Agent 770 may be configured to interface with one or more specialized generative models, and may be configured to receive a job definition and/or prompt from Jobs/AI Chains 750. In some embodiments, the AI agents 770 may select or construct a prompt template tailored to the specialized models. In some embodiments, the AI agents 770 and/or the compute manager 745 may invoke the underlying model through a model server or framework such as Lang-Chain VLLM 725, thereby causing the requisite Gen AI models 720 to be loaded to one or more GPU(s) 715, or other specialized hardware.

The process of loading models to the GPU may involve retrieving the requisite Gen AI models 720 may be retrieved from the generative AI models 520 stored in a file system 730 in accordance with the request. Examples of Gen AI models 520 include a diffusion model fine-tuned for avatar motion, an LLM fine-tuned to casino-regulated speech, and a model trained to produce decorative background textures. GPU(s) 514 denote an array of specialized, parallel-processing units. Other examples of suitable specialized hardware include an FPGA and neuromorphic processors. Multiple GPUs or other specialized hardware, or compute components therein, can be assigned distinct jobs concurrently, enabling parallel generation.

The AI agents 770 may validate the model output against the component criterion which may be predefined, defined by the request received at the work queue, or the like. The AI agents 770 may either accept the output, regenerate the request with the model, or signal Compute Manager 745 to cancel a request, for example after exceeding a permissible regeneration count or timeout. Verified outputs from the agents may be provided back to data processing 755, and specifically, a post-processing module 765. In some embodiments, the postprocessing module 765 may apply game- user- or property-specific enhancements, such as personalized skins, branding, or the like. Post-processing module 765 may synchronize output provided by multiple agents and perform final transformations to combine the output into an asset aligned with the request received from the game. The compute manager 745 can then provide the resulting asset to the game program.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system comprising:
a specialized hardware configured to execute one or more generative artificial intelligence (AI) models;
one or more processors; and
one or more computer readable media comprising computer readable code executable by the one or more processors to:
initiate a gaming session for an electronic game at an electronic gaming machine, wherein the electronic game is associated with one or more generic gaming assets,
detect one or more characteristics of the gaming session, and
generate, by an asset creation module, one or more session-specific gaming assets based on the one or more characteristics and using the one or more generative AI models, and
replace, during the gaming session, one or more of the generic gaming assets with the one or more session-specific gaming assets,
wherein the gaming session proceeds using the one or more session-specific gaming assets.

2. The system of claim 1, wherein the specialized hardware is comprised in the electronic gaming machine.

3. The system of claim 1, further comprising computer readable code to:
determine a compliance score for the one or more of the session-specific gaming assets,
wherein the one or more of the generic gaming assets are replaced with the one or more session-specific gaming assets based on a determination that the compliance score satisfies a criterion.

4. The system of claim 1, wherein the asset creation module is configured to generate a variation of one or more gaming assets based on the one or more generic gaming assets and the one or more characteristics of the gaming session.

5. The system of claim 4, wherein the one or more characteristics of the gaming session comprises player data from a player profile.

6. The system of claim 4, wherein the one or more characteristics of the gaming session comprises behavioral data during the gaming session.

7. The system of claim 4, wherein the asset creation module is further configured to generate the variation of the one or more generic gaming assets based on one or more parameters received from a casino management system.

8. A non-transitory computer readable medium comprising computer readable code executable by one or more processors to:
initiate a gaming session for an electronic game at an electronic gaming machine, wherein the electronic game is associated with one or more generic gaming assets,
detect one or more characteristics of the gaming session, and
generate, by an asset creation module, one or more session-specific gaming assets using the one or more characteristics of the gaming session, and
replace, during the gaming session, one or more of the generic gaming assets with the one or more session-specific gaming assets,
wherein the gaming session proceeds using the one or more session-specific gaming assets.

9. The non-transitory computer readable medium of claim 8, further comprising computer readable code to:
determine a compliance score for the one or more of the session-specific gaming assets,
wherein the one or more of the generic gaming assets are replaced with the one or more session-specific gaming assets based on a determination that the compliance score satisfies a criterion.

10. The non-transitory computer readable medium of claim 8, wherein the asset creation module further generates the one or more session-specific assets using a generative AI model and based on the one or more generic gaming assets and the one or more characteristics of the gaming session.

11. The non-transitory computer readable medium of claim 10, wherein the computer readable code to generate the one or more session-specific gaming assets comprises computer readable code to perform a call to a specialized hardware configured to execute the generative AI model.

12. The non-transitory computer readable medium of claim 10, wherein the one or more characteristics of the gaming session comprises player data from a player profile.

13. The non-transitory computer readable medium of claim 10, wherein the one or more characteristics of the gaming session comprises behavioral data during the gaming session.

14. The non-transitory computer readable medium of claim 8, wherein the one or more generic gaming assets comprise one or more media items for the electronic game.

15. A method comprising:
initiating a gaming session for an electronic game at an electronic gaming machine, wherein the electronic game is associated with one or more generic gaming assets,
detecting one or more characteristics of the gaming session, and
generating, by an asset creation module, one or more session-specific gaming assets using the one or more characteristics of the gaming session, and
replacing, during the gaming session, one or more of the generic gaming assets with the one or more session-specific gaming assets,
wherein the gaming session proceeds using the one or more session-specific gaming assets.

16. The method of claim 15, further comprising:
determining a compliance score for the one or more of the session-specific gaming assets,
wherein the one or more of the generic gaming assets are replaced with the one or more session-specific gaming assets based on a determination that the compliance score satisfies a criterion.

17. The method of claim 15, wherein the asset creation module further generates the one or more session-specific assets using a generative AI model and based on the one or more generic gaming assets and the one or more characteristics of the gaming session.

18. The method of claim 17, wherein the one or more characteristics of the gaming session comprises player data from a player profile.

19. The method of claim 17, wherein the one or more characteristics of the gaming session comprises behavioral data during the gaming session.

20. The method of claim 15, wherein the one or more generic gaming assets comprise one or more media items for the electronic game.
